(19) United States
(12) Patent Application Publication
(10) Pub. No.: US 2024/0400233 A1
(43) Pub. Date: Dec. 5, 2024

(54) DEVICE FOR CONTROLLING THE ANGULAR VELOCITY OF A SPACECRAFT, AND CORRESPONDING SPACECRAFT

(71) Applicant: AIRBUS DEFENCE AND SPACE SAS, Toulouse Cedex 4 (FR)

(72) Inventors: Laurent BOYER, Toulouse Cedex 4 (FR); Kristen LAGADEC, Toulouse Cedex 4 (FR)

(21) Appl. No.: 18/694,826

(22) PCT Filed: Sep. 20, 2022
(86) PCT No.: PCT/FR2022/051767

§ 371 Date: Mar. 22, 2024

(30) Foreign Application Priority Data
Sep. 24, 2021 (FR) FR2110081

(51) Int. Cl. B64G 1/24; B64G 1/32

(52) U.S. Cl. CPC B64G 1/244; B64G 1/32

(57) ABSTRACT

A device for controlling the angular velocity of an out-of-service spacecraft is disclosed, in which the device makes it possible to facilitate the operations of active removal of the spacecraft as space debris. The device includes a stator and a rotor able to move on a rotation axis with respect to the stator, the stator is configured to be driven by the spacecraft to be stabilized, the rotor is configured to orient itself along the terrestrial magnetic field. The stator includes an electrically conductive non-ferromagnetic body while the rotor includes a magnetized system configured to induce, in the stator, eddy currents for braking a relative movement of the rotor with respect to the stator.

### FIELD OF THE INVENTION

The field of the invention is that of controlling the attitude of spacecraft, such as satellites.

The invention relates more particularly to a device for controlling the angular velocity of an out-of-service spacecraft.

The invention thus has applications, in particular, but not exclusively, for all spacecraft for which an operation of removal at the end of life must be envisaged.

### PRIOR ART AND DRAWBACKS THEREOF

Out-of-service spacecraft contribute to the accumulation of space debris. The present in space of such space debris is a problem since it constitutes pollution as the debris in question follows pathways that may intersect the orbits of functional spacecraft, which creates risks of collision. Furthermore, collisions of debris with each other increase the total number of items of debris, which further accentuates the risk of collision for functional craft.

In this context, regulations provide that an out-of-service satellite must not be left in orbit for more than 25 years. If such a satellite is flying at a height greater than approximately 600 km, atmospheric drag does not suffice to cause it to fall to Earth. Thus either such a satellite is configured to descend by its own means or, if it breaks down before being able to do so, it will be necessary for another spacecraft to join it to cause it to descend to Earth.

However, even in the case of a satellite in a sufficiently low orbit for atmospheric drag to be sufficient to cause it to fall to Earth, it is necessary to check that no risk is associated with such a fall. For example, if the satellite contains too many parts liable to survive re-entry to atmosphere (steel, titanium, ceramics), this could represent a risk on the ground if the satellite were to enter passively (i.e. just anywhere). It is then necessary for the satellite to be capable of effecting a so-called controlled re-entry requiring significantly more propellants and trickier operations.

Thus, in order to capture and deorbit space debris such as a decommissioned satellite, spacecraft are known adapted to perform maneuvers such as anchoring to the debris, so as to form a composite, such as for example deorbiting satellites such as those described in applications EP2746163 and EP2671804. It will nevertheless be understood that the rotation velocity of the out-of-service satellite remains a limiting factor in success of the capture phase for such missions. It is in fact frequent for an out-of-service satellite to be driven in a high angular velocity, either because of a fatal failure that also interrupted the mission (propulsion breakdown, collision with debris), or because of the accumulation of small external disturbances (solar-radiation pressure) over long periods. Furthermore, even in the case of a successfully implemented capture, the immediate continuation of the operations for controlling the composite is incompatible with a high rotation velocity, in particular when the out-of-service satellite is connected to the deorbiter satellite by flexible links, such as for example a harpoon or a net.

Patent EP3538441 is also known, which teaches a projectile comprising an external enclosure separated by a viscous fluid from a magnetized internal body.

Patent document EP0087628 entitled “Magnetic bearing wheel for an artificial satellite” of Mitsubishi Electric is known.

Patent document U.S. Pat. No. 3,526,795 entitled “TORQUE REACTION ATTITUDE CONTROL DEVICE» of PECS WILLIAM is known.

Patent document U.S. Pat. No. 6,191,513 entitled “Stator-controlled magnetic bearing» of CHEN H MING is known.

Patent document U.S. Pat. No. 4,062,509 entitled “Closed loop roll/yaw control system for satellites” of LUDWIG MUHLFELDER is known.

There is in general terms a need for improving the techniques for controlling an out-of-service spacecraft.

### DISCLOSURE OF THE INVENTION

The invention relates to a device for controlling the angular velocity of an out-of-service spacecraft making it possible to facilitate the operations of active removal of the spacecraft as space debris. Such an angular-velocity control device comprises a stator and a rotor able to move on a rotation axis with respect to the stator, the stator being intended to be driven by the spacecraft to be stabilized, the rotor being intended to orient itself along the terrestrial magnetic field. The stator comprises an electrically conductive non-ferromagnetic body while the rotor comprises a magnetized system configured to induce, in the stator, eddy currents for braking a relative movement of the rotor with respect to the stator.

Thus, the invention proposes a novel and inventive solution for controlling the attitude of a decommissioned spacecraft (i.e. on board which no energy source is available). This aim is achieved by a passive magnetic damping device attached to the structure of the platform, where a rotor equipped with magnets is free to turn inside a non-ferromagnetic conductive stator (i.e. so as not to become magnetized over time). The magnets of the magnetized system are placed facing the body, for example made from aluminum. Even if the spacecraft pivots, the rotor remains aligned with the geomagnetic field: the differential angular velocity between the rotor and the platform creates eddy currents in the stator and thus dissipates the rotational kinetic energy, tending to stop the rotation of the spacecraft with respect to the terrestrial magnetic field.

In some embodiments, the rotor is guided in at least one housing in the stator, the rotor comprising at least one magnet cooperating with at least one counter-magnet disposed in said housing in the stator, so as to cause a magnetic levitation of the rotor with respect to the stator when the attitude control device is in microgravity and also when the attitude control device is in terrestrial gravity. Two magnets and counter-magnets act for example in two opposite directions and along the rotation axis of the rotor.

Thus, friction is minimized at the contact between the rotor and the stator.

In some embodiments, the angular-velocity control device comprises means for maintaining respective magnetized zones of the stator and of the rotor at a distance, the distance-maintaining means being arranged to withstand forces at takeoff and at jettison.

Thus the magnets and the corresponding counter-magnets do not have to support the weight of the rotor, e.g. when gravity is present or during accelerations (e.g. at the launch of a satellite comprising such a device).

In some embodiments, the distance-maintaining means comprise at least one ring of the rotor and a shoulder of the stator. The ring is intended to cooperate with the shoulder disposed at a distance and facing the ring in an axial direction and in a radial direction. The ring can come into abutment against the shoulder, example during acceleration, thus guaranteeing maintenance at a distance. The shoulder is disposed so as to guarantee a minimum distance between the respective magnetized zones of the stator and of the rotor.

In some embodiments, the rotor comprises parts constituting a pivot axis and a flexible diaphragm. The ring of the rotor is mechanically connected to the pivot axis by the diaphragm. The ring can carry the magnetized system, while the pivot axis carries the pair or pairs of magnets and counter-magnets.

In the present invention, a satellite can for example comprise magnets for braking, magnets for orientation with respect to the terrestrial magnetic field and magnets and counter-magnets for levitation of the axis of the rotor.

Thus, the pivot axis does not have to withstand any mechanical stress making it possible to block any tilting movement of the pivot axis with respect to the rotation axis.

In some embodiments, the magnetized system comprises a plurality of braking magnets disposed along a plane perpendicular to the rotation axis of the rotor.

In some embodiments, the magnetic moments of the braking magnets are added together in a non-zero component in the plane perpendicular to the rotation axis of the rotor so that the braking magnets also enable the rotor to be oriented along the terrestrial magnetic field.

Such a configuration makes it possible to combine the compass function and the current-induction function.

In some embodiments, the magnetic moments of several of the braking magnets are substantially perpendicular to the plane perpendicular to the rotation axis of the rotor, so that their magnetic field passes through the plane perpendicular to the rotation axis of the rotor to induce eddy currents in at least two zones of the stator body located facing on either side of the plane perpendicular to the rotation axis of the rotor. The stator has for example a U-shaped profile coming around and on either side of the ring.

Thus, the quantity of currents induced by a magnet of the rotor is doubled compared with an implementation wherein the magnetic moment of the magnet is substantially parallel to the rotation plane of the rotor (i.e. perpendicular to the rotation axis of the rotor).

In some embodiments, the magnetic moments of several of the braking magnets form an oblique angle with respect to said plane perpendicular to the rotation axis of the rotor.

Such a configuration makes it possible to combine the compass function and the doubling of the induced currents.

The invention also relates to a spacecraft comprising one or more angular-velocity control devices as described above (according to any one of the aforementioned embodiments).

In some embodiments, the spacecraft furthermore comprises means for controlling attitude along three axes, adapted to stabilize the attitude of the spacecraft in activity. The device or devices for controlling the angular velocity of the craft when it is out of service act simultaneously on the means for controlling the attitude of the spacecraft in activity and exert a negligible action with respect to these means for controlling the attitude of the spacecraft in activity.

In some embodiments, each angular-velocity control device is arranged so that the rotation axis of the rotor forms an angle of less than or equal to 45° with a greatest-inertia axis of the spacecraft, so that the out-of-service spacecraft tends towards a rotation movement about this greatest-inertia axis.

A first advantage of the invention is to allow a reduction in the angular velocity of the satellite to be captured, prior to capture thereof, which is thus facilitated. The present invention thus makes it possible to avoid an out-of-service satellite being driven in a high angular velocity, either because of a fatal failure that also caused the interruption of the mission, such as a propulsion breakdown, or a collision with debris, or because of the accumulation of small external disturbances caused for example by solar-radiation pressure, over long periods.

### LIST OF FIGURES

Other aims, features and advantages of the invention will emerge more clearly from the reading of the following description, given by way of simple illustrative and non-limitative example, in relation to the figures, among which:

FIG. 1 shows a device for controlling the angular velocity of a spacecraft according to an example embodiment of the invention;

FIG. 2 shows a device for controlling the angular velocity of a spacecraft according to another example embodiment of the invention;

FIG. 3a shows a configuration of the braking magnets of a device for controlling the angular velocity of a spacecraft according to an example embodiment of the invention;

FIG. 3b shows a configuration of the braking magnets of a device for controlling the angular velocity of a spacecraft according to another example embodiment of the invention;

FIG. 4a shows a detailed view of an axial part of a device for controlling the angular velocity of a spacecraft according to an example embodiment of the invention, when the device is subjected to a first mechanical stress;

FIG. 4b shows a detailed view of the axial part of the device of [FIG. 4a], when the device is subjected to a second mechanical stress;

FIG. 4c shows a detailed view of the axial part of the device of [FIG. 4a], when the device is subjected to a third mechanical stress;

FIG. 5 shows a view in axial section of a device for controlling the angular velocity of a spacecraft equipped with a flexible diaphragm according to an example embodiment of the invention;

FIG. 6 shows a simplified model of a device for controlling the angular velocity of a spacecraft making it possible to predict the derotation time constant of the spacecraft;

FIG. 7 shows a spacecraft equipped with two devices for controlling the angular velocity of a spacecraft according to an example embodiment of the invention.

### DETAILED DESCRIPTION OF EMBODIMENTS OF THE INVENTION

The general principle of the invention is based on a device for controlling the angular velocity of a spacecraft making it possible in particular to facilitate the operations of removing the spacecraft as space debris. Such a device comprises a stator and a rotor able to move on a rotation axis with respect to the stator, the stator being intended to be driven by the spacecraft to be stabilized, the rotor being intended to orient itself along the terrestrial magnetic field. The stator comprises an electrically conductive non-ferromagnetic body while the rotor comprises a magnetized system configured to induce, in the stator, eddy currents for braking a relative movement of the rotor with respect to the stator. The rotor behaves as a compass needle by virtue of a magnetic-moment bias provided by an asymmetric arrangement of the polarities of the braking magnet or by virtue of dedicated orientation magnets.

Thus, even in the absence of an energy source on board the spacecraft, the rotor remains aligned with the terrestrial magnetic field (compass function). The differential angular velocity between the rotor and the spacecraft creates eddy currents in the stator and thus dissipates the rotational kinetic energy, tending to stop the rotation movement of the spacecraft with respect to the terrestrial magnetic field. The rotation speed of the spacecraft is thus controlled.

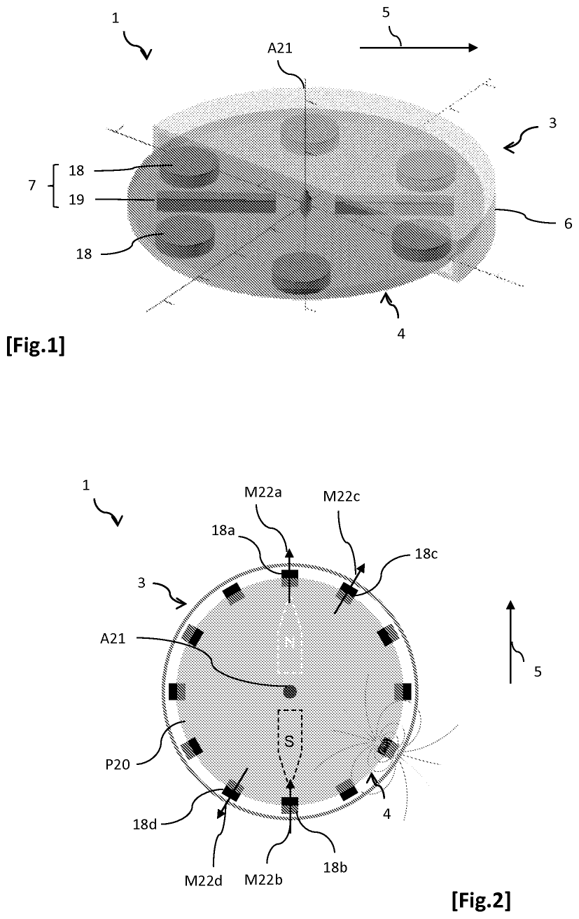

In relation to [FIG. 1], a device 1 for controlling the angular velocity of a spacecraft 2 according to an example embodiment of the invention is now presented.

As described above in relation to [FIG. 7], the device 1 according to the invention makes it possible in particular to control the angular velocity of the spacecraft 2 when the latter is out of service. This makes it possible for example to facilitate the operations of active removal of the spacecraft 2 as space debris.

Returning to [FIG. 1], the device 1 comprises a stator 3 and a rotor 4 able to move on a rotation axis A21 of the rotor 4 with respect to the stator 3. The stator is for example secured to the frame of the satellite. According to the application to controlling the angular velocity of the spacecraft 2, the stator 3 is intended to be driven by the spacecraft 2 to be stabilized. The rotor 4 is for its part intended to orient itself along the terrestrial magnetic field 5.

Moreover, the stator 3 comprises an electrically conductive body 6, for example made from aluminum, while the rotor 4 comprises a magnetized system 7 configured to induce, in the stator 3, eddy currents for braking a relative movement of the rotor 4 with respect to the stator 3.

In this way a passive magnetic damping device intended to be secured to the structure of the spacecraft 2 is obtained, where the rotor 4 equipped with the magnetized system 7 is free to turn inside a stator 3.

The body 6 of the stator 3 is electrically conductive and non-ferromagnetic so as not to become magnetized over time. The body 6 is for example made from aluminum or copper.

Moreover, according to the example embodiment in [FIG. 1], the magnetized system 7 comprises firstly braking magnets 18 and secondly orientation magnets 19. The braking magnets 18 are configured to induce, in the stator 3, the eddy currents for braking a relative movement of the rotor 4 with respect to the stator 3. The orientation magnets 19 are configured to maintain the orientation of the rotor 4 with respect to the terrestrial magnetic field 5 (compass function).

In relation to [FIG. 2], an angular-velocity control device 1 according to another example embodiment of the invention is now presented.

According to the example embodiment in [FIG. 2], the magnetized system 7 comprises a plurality of braking magnets 18a, 18b, 18c, 18d, disposed along a plane P20 perpendicular to the rotation axis A21 of the rotor 4 with respect to the stator 3.

More particularly, the magnetic moments M22a and M22b of the braking magnets 18a and 18b are added together in a non-zero component in the plane P20 so that the braking magnets 18a and 18b also enable the rotor 4 to be oriented along the terrestrial magnetic field 5.

Thus, in this example embodiment, the braking magnets 18 fulfil the function of orientation magnets 19 (compass function). The braking magnets 18 and the orientation magnets 19 are here the same magnets.

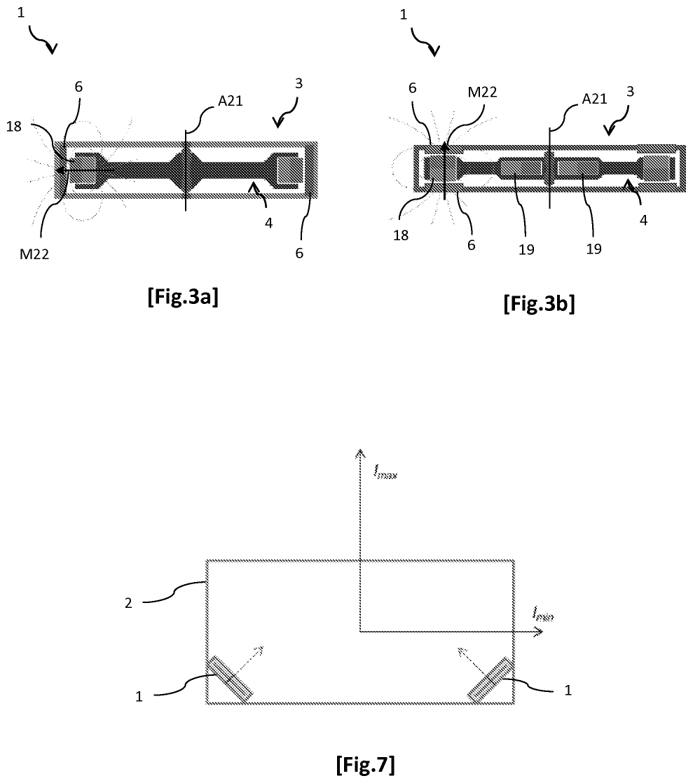

In relation to [FIG. 3a], a configuration of the braking magnets 18 according to an example embodiment of the invention is now presented.

More particularly, the magnetic moments M22 of several braking magnets 18 are here substantially parallel to the plane P20 perpendicular to the rotation axis A21 of the rotor 4.

In such a radial configuration, the radius of the path of the induced eddy currents is maximized in the body 6. The energy dissipation is thus also maximized.

Moreover, the same braking magnets 18 can be used also to fulfil the function of orientation of the rotor 4 with respect to the stator 3, as described above in relation to [FIG. 2].

According to such a configuration of the braking magnets 18, it is also easier to control the size of the air gap between the magnets 18 and the body 6 of the stator 3 (e.g. to address the problem of launch vibrations or of the free clearance in the pivot of the rotor 4) or to house magnets 18 with a larger aspect ratio (e.g. a greater height of the magnets 18 allows a larger air gap).

Moreover, the casing of the stator 3 may be made from any material, for example from plastic, with simply a track 6 made from non-ferromagnetic material (e.g. from aluminum or copper) forming a housing or disposed in a housing produced in the stator 3, facing the magnets 18. This housing extends for example around the stator with a U-shaped profile. The stator comprises for example a cylindrical ring fitting in this housing.

In relation to [FIG. 3b], a configuration of the braking magnets 18 according to another example embodiment of the invention is now presented.

More particularly, the magnetic moments M22 of several braking magnets 18 are here substantially perpendicular to the plane P20. In other words, the magnetic moments M22 of the braking magnets 18 in question are here substantially parallel to the rotation axis A21 of the rotor 4.

Thus, the magnetic field of the braking magnets 18 passes through the plane P20 to induce eddy currents in at least two zones of the body 6 of the stator 3 located facing on either side of the plane P20 in question. The eddy currents thus induced are potentially doubled compared with a radial configuration of the braking magnets 18 as described above in relation to [FIG. 3a]. However, in the normal configuration of the braking magnets 18 of [FIG. 3b], the braking magnets 18 cannot at the same time fulfil the function of orientation of the rotor 4 with respect to the stator 3. Additional magnets fulfilling the function of orientation of the rotor 4 with respect to the stator 3 are here necessary, for example orientation magnets 19 as described above in relation to [FIG. 1]. In other implementations, the additional magnets fulfilling the function of orientation of the rotor 4 with respect to the stator 3 are other braking magnets 18 in radial configuration as described above in relation to [FIG. 3a]. In this way a mixed configuration is obtained with some braking magnets 18 in normal configuration and some braking magnets 18 in radial configuration.

In other implementations, the magnetic moments M22 of several braking magnets 18 form an oblique angle with respect to the plane P20 perpendicular to the rotation axis A21 of the rotor 4. For example, the magnetic moments M22 in question form an angle with the rotation axis A21 of the rotor 4 of between 10 degrees and 80 degrees, preferably between 30 degrees and 60 degrees. In such a configuration, eddy currents are also induced on either side of the plane P20 in question. Moreover, a non-zero component of the total magnetic moment of the braking magnets 18 can thus be obtained in the plane P20 in question. In this way, the braking magnets 18 also fulfil the function of orientation of the rotor 4 with respect to the stator 3 (compass function).

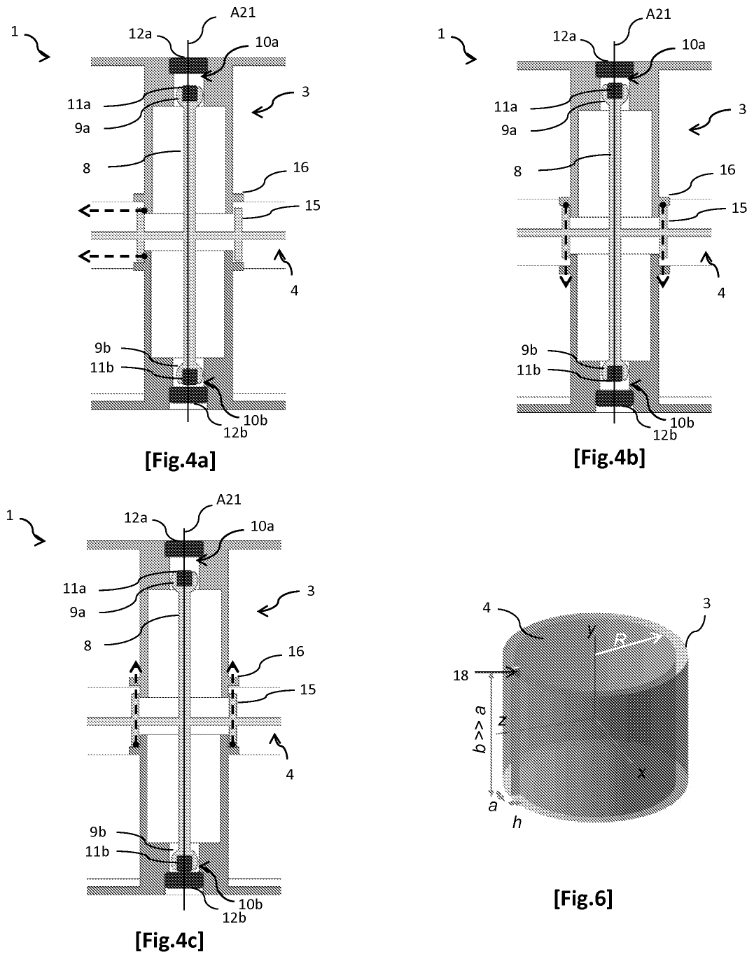

In relation to [FIG. 4a], [FIG. 4b] and [FIG. 4c], the axial part of the angular-velocity control device 1 according to an example embodiment of the invention is now presented.

In practice, the rotor 4 must be adjusted to the stator 3 with sufficient precision for the braking magnets 18 to move typically at less than 1 mm from the body 6 of the stator 3 without ever touching. Moreover, the means for adjusting the rotor 4 to the stator 3 must cause the least friction possible, so that the rotor 4 is always free to turn. The friction must be a fraction of the magnetic torque driving the rotor 4. This is not necessarily a problem for conditions in orbit, when the forces and torques acting on the rotor 4 are small. However, this may be a problem during tests on the ground, in order to allow testing of the device 1 before putting into orbit.

For this purpose, the rotor 4 is here guided in a corresponding housing 10a, 10b of the stator 3. In the present example embodiment, it is the two ends of a pivot axis 4 of the rotor 4 that are guided in a corresponding housing 10a, 10b of the stator 3. In other example embodiments, the rotor 4 does not comprise a pivot axis 4 as such. In this case, they are for example swivels disposed along the rotation axis A21 and intended to be each guided with a corresponding housing of the stator 3.

Returning to [FIG. 4a], [FIG. 4b] and [FIG. 4c], each end of the pivot axis 8 comprises one (or more) magnet 11a, 11b cooperating with one (or more) counter-magnet 12a, 12b disposed in the corresponding housing 10a, 10b of the stator 3. Thus a magnetic levitation of the rotor 4 with respect to the stator 3 is caused when the attitude control device 1 is in microgravity, but also when the attitude control device 1 is in terrestrial gravity. Thus, it is possible to test the device 1 on the ground.

For example, the allowed range of movement along the rotation axis A21 for the rotor 4 is such that, on the Earth (i.e. under 1 g) and when the device is disposed so that the axis A21 is vertical, the magnetic suspension of the rotor 4 with respect to the stator 3 connected to the pair consisting of magnet 11a, 11b and counter-magnet 12a, 12b located in the top part of the device 1 has a negligible effect on the pivot axis 8. Likewise, in orbit (i.e. under zero g or in microgravity), the two suspensions connected to the two pairs consisting of magnet 11a, 11b and counter-magnet 12a, 12b have a negligible effect on the pivot axis 8 when the latter is halfway along its allowed range of movement in translation along the axis A21, which makes the friction even smaller.

In other example embodiments, the rotor 4 and the stator 3 are not equipped with such pairs consisting of magnet 11a, 11b and counter-magnet 12a. The frictions are for example reduced via mechanical means of the ball bearing type or friction-reducing materials.

Returning to [FIG. 4a], [FIG. 4b] and [FIG. 4c], the angular-velocity control device 1 must withstand the launch loads without any clamping mechanism, the rotor 4 being free to move at any moment. However, in order to minimize friction, a non-zero mechanical tolerance is necessary between the rotor 4 and the stator 3. Potentially, there may be a mechanical clearance between the rotor 4 and the stator 3 when the rotor 4 reaches the ends of its allowed range of movement in translation and in rotation. The pivot axis 8 and the pairs consisting of magnet 11a, 11b and counter-magnet 12a, 12b are not necessarily designed to support the weight of the rotor 4 or to withstand shocks.

To address this problem, the angular-velocity control device 1 comprises here means for maintaining at a distance the respective magnetized zones of the stator 3 and of the rotor 4, i.e. the zones in which the pairs consisting of magnet 11a, 11b and counter-magnet 12a, 12b are implemented. The distance-maintaining means in question are arranged to withstand forces both at takeoff and at jettison, here for the 3 possible translations between the rotor 4 and the stator 3 (the 3 translations in question are indicated by the broken arrows on [FIG. 4a], [FIG. 4b] and [FIG. 4c]).

According to the present example embodiment, the distance-maintaining means comprise a ring 15 of the rotor 4 and a shoulder 16 of the stator 3. The ring 15 is intended to cooperate with the shoulder 16 disposed at a distance and facing the ring 15 in an axial direction and in a radial direction. More particularly, the shoulder 16 is disposed so as to guarantee a minimum distance between the respective magnetized zones of the stator 3 and of the rotor 4.

In other example embodiments, a plurality of rings are implemented on the rotor 4. The rings in question are configured to cooperate with corresponding shoulders on the stator 3.

In other example embodiments, other forms of distance-maintaining means are considered. For example, the ring (or rings) can be implemented on the stator 3 and the corresponding shoulder (or shoulders) are implemented on the rotor 4.

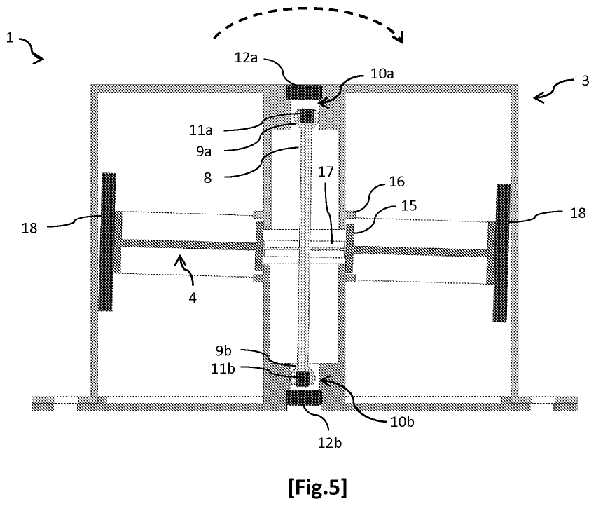

In relation to [FIG. 5], an angular-velocity control device 1 equipped with a flexible diaphragm 17 according to another example embodiment of the invention is now presented.

More particularly, the ring 15 of the rotor 4 is mechanically connected to the pivot axis 8 by the diaphragm 17. The diaphragm 17 is configured so that, when a tilting movement tending to make the pivot axis 8 deviate is imparted to the rotor 4 (tilting movement symbolized by the broken arrow on [FIG. 5]):
firstly, each of the two ends of the pivot axis 8 comes into a position of abutment against a wall of the corresponding housing 10a, 10b of the stator 3 while the diaphragm 17 remains non-flexed; then
secondly, the two ends of the pivot axis 8 remaining in the abutment position, the flexion of the diaphragm 17 causes the ring 15 and the shoulders 16 to come into abutment to block the tilting movement of the rotor 4 in a position guaranteeing a minimum space between the braking magnets 18 and the stator 3.

Thus, during such a tilting movement, the rotor 4 is prevented from touching the stator 3 while guaranteeing that the pivot axis 8 does not have to withstand the mechanical stress making it possible to block the tilting movement in question.

In relation to [FIG. 6], a simplified model of the angular-velocity control device 1 according to an example embodiment of the invention is now presented.

More particularly, such a model makes it possible to estimate the derotation time constant of a spacecraft to which an angular-velocity control device according to the present technique would be attached.

As a simplifying hypothesis, a braking magnet 18 is considered here with a length b sufficiently great with respect to its width a that it can be considered to be infinite. The braking magnet 18 is housed radially at the periphery of a cylindrical rotor 4 of infinite length along its axis (y axis) and of radius R. The braking magnet 18 moves at a supposedly infinitesimal distance ε (=air gap) from a cylindrical metal casing, also of infinite length along the axis of the cylinder, modelling the stator 3.

The magnet 18 is magnetized radially and its height h along the radial direction is sufficiently great with respect to its width for it also to be able to be considered to be infinite. Because of the infinite height of the magnet 18, the magnetic field B generated by the magnet 18 at its surface approaches the asymptotic value, characterized by the remanence, Br, of the material:

$$B = \frac{{B}_{r}}{2} \qquad [ Math . 1 ]$$

According to such a one-dimensional model, the electrical field and the currents have non-zero components solely along the y axis. This simplifies the analysis, since the Maxwell-Faraday law:

$$∇ \times E = - \frac{\partial B}{\partial t} \qquad [ Math . 2 ]$$

is reduced to a single differential equation:

$$\frac{\partial {E}_{y}}{\partial x} = - \frac{\partial {B}_{z}}{\partial t} = - \frac{\partial {B}_{z}}{\partial x} R ω \qquad [ Math . 3 ]$$

with R the radius of the cylinder and ω the angular velocity of rotation of the cylinder about the axis thereof. As the electrical field and the magnetic field are zero at infinity, integrating the equation [Math. 3] according to x is simple. As a result, the axial electrical field is proportional to the radial magnetic field in accordance with the following equation:

$${E}_{y} = - B \cdot R ω = - \frac{{B}_{r}}{2} \cdot R ω \qquad [ Math . 4 ]$$

The electrical power P dissipated by the unit of volume V of the casing of the stator 3 (considering a material of resistivity ρ) for a single magnet 18 is then:

$$\frac{d F}{d V} = \frac{1}{ρ} \cdot {E}_{y}^{2} = \frac{{B}_{r}^{2}}{4 ρ} \cdot {R}^{2} {ω}^{2} \qquad [ Math . 5 ]$$

In order to obtain the dissipated total electrical power P, the previous equation must be integrated over the volume where the phenomenon occurs, supposed to be e×a×b (where e is the thickness of the casing of the stator 3, a is the width of the magnet in the tangential direction, and b is the actual and finite length of the magnet along y). In this way the following is obtained:

$$P = \frac{{B}_{r}^{2}}{4 ρ} \cdot eab \cdot {R}^{2} {ω}^{2} \qquad [ Math . 6 ]$$

When a rotor 4 is considered with n braking magnets 18, the dissipated total power is supposed proportional to n (supposing that the magnets 18 do not interact with each other). When the stator 3 is driven by the spacecraft 2 to be stabilized and the rotor remains oriented along the terrestrial magnetic field, the dissipated total electrical power P corresponds in fact to a loss of kinetic energy of the satellite Ė=Iω\dot{ω}, with I the inertia of the spacecraft 2 to be stabilized about the axis of the cylinder. In this way the following is obtained:

$$nP = I ω \dot{ω} = \frac{{B}_{r}^{2}}{4 ρ} \cdot neab \cdot {R}^{2} {ω}^{2} \qquad [ Math . 7 ]$$

From the previous equation a time constant τ can be deduced for the exponential decrease in the angular velocity:

$$τ = \frac{ω}{\dot{ω}} = \frac{4 ρ I}{{B}_{r}^{2} {R}^{2} \cdot neab} \qquad [ Math . 8 ]$$

By way of example, a time constant τ of 28 days is obtained for the following values of the parameters of the equation [Math. 8]:
number of magnets 18, n: 8;
width of a magnet 18 in the tangential direction, a: 3 mm;
actual length of the magnet along y, b: 15 mm;
thickness of the casing of the stator 3, e: 1 mm;
resistivity of the material, ρ: 2.7×10-⁸ Ω·m;
radius of the rotor 4, R: 2.5 cm;
remanence of a magnet, Br: 1 T; and
inertia of the spacecraft 2 to be stabilized about the axis of the cylinder, I: 5000 kg·m².

In relation to [FIG. 7], a spacecraft 2 equipped with two angular-velocity control devices 1 according to an example embodiment of the invention is now presented.

More particularly, the stator 3 of each device 1 is attached to the spacecraft 2 so as to be driven by the spacecraft 2. The rotor 4 of each device 1 orients itself along the terrestrial magnetic field 5.

According to the present example embodiment, two angular-velocity control devices 1 are implemented in the spacecraft 2 to be stabilized when it is out of service. This is because an angular-velocity control device 1 according to the present invention cannot theoretically damp angular velocities normal to its axis. However, an out-of-service spacecraft 2 will naturally tend to follow a rotation movement about its principal axis of maximum inertia. Thus, if such an angular-velocity control device 1 is not installed so as to have its rotation axis A21 strictly perpendicular to the main axis of maximum inertia, residual degrees of angular rotation can be expected to be observed.

Thus, if only one angular-velocity control device 1 is sufficient in theory to damp the rotation of the spacecraft 2 about the 3 axes of inertia, it can be advantageous in practice to implement two or three angular-velocity control devices 1 for redundancy purposes.

However, in other example embodiments, the spacecraft 2 is equipped with a single angular-velocity control device 1.

In some example embodiments, the rotation axis A21 of the rotor 4 of the angular-velocity control device (or devices) 1 forms an angle of less than or equal to 45° with the greatest-inertia axis of the spacecraft 2 (axis denoted “Iₘₐₓ” in [FIG. 7]), so that the out-of-service spacecraft 2 tends towards a rotation movement about this greatest-inertia axis. This is because the rotation of the spacecraft 2 will naturally tend towards a rotation about its greatest-inertia axis (so-called “flat spin” phenomenon in accordance with English terminology). Thus, an arrangement according to which the rotation axis or axes A21 of the rotor or rotors 4 of the angular-velocity control device or devices 1 form an angle of less than or equal to 45° with the greatest-inertia axis of the spacecraft 2 makes it possible to guarantee dissipation of the rotation kinetic energy of the spacecraft 2 about its greatest-inertia axis, having the consequence of braking the rotation of the spacecraft.

The spacecraft 2 in activity furthermore comprises means for controlling attitude along three axes, adapted to stabilize the attitude of the spacecraft in activity. The angular-velocity control device or devices 1 act simultaneously on the means for controlling the attitude of the spacecraft in activity but exert negligible action with respect to these means for controlling the attitude of the spacecraft in activity.

In this way, the angular-velocity control device or devices 1 have a negligible effect on the attitude control of the spacecraft 2 when the latter is in activity, but make it possible to control the angular velocity of the spacecraft 2 when the latter is out of service.

1. A device for controlling the angular velocity of an out-of-service spacecraft making it possible to facilitate the operations of active removal of the spacecraft as space debris, comprising a stator and a rotor able to move on a rotation axis with respect to the stator,
wherein the stator is configured to be driven by the spacecraft to be stabilized,
wherein the rotor is configured to orient itself along the terrestrial magnetic field, and
wherein the stator comprises an electrically conductive non-ferromagnetic body while the rotor comprises a magnetized system configured to induce, in the stator, eddy currents for braking a relative movement of the rotor with respect to the stator.

2. The angular-velocity control device according to claim 1, wherein the rotor is guided in at least one housing in the stator, the rotor comprising at least one magnet cooperating with at least one counter-magnet disposed in said housing in the stator, so as to cause a magnetic levitation of the rotor with respect to the stator when the attitude control device is in microgravity and also when the attitude control device is in terrestrial gravity.

3. The angular-velocity control device according to claim 1, further comprising means for maintaining respective magnetized zones of the stator and of the rotor at a distance, the distance-maintaining means being arranged to withstand forces at takeoff and at jettison.

4. The angular-velocity control device according to claim 3, wherein the distance-maintaining means comprise at least one ring of the rotor and a shoulder of the stator, the ring is configured to cooperate with the shoulder disposed at a distance and facing said ring in an axial direction and in a radial direction, said shoulder being disposed so as to guarantee a minimum distance between the respective magnetized zones of the stator and of the rotor.

5. The angular-velocity control device according to claim 4, wherein the rotor comprises parts constituting a pivot axis and a flexible diaphragm, said ring of the rotor being mechanically connected to the pivot axis by the diaphragm.

6. The angular-velocity control device according to claim 1, wherein the magnetized system comprises a plurality of braking magnets disposed along a plane perpendicular to the rotation axis of the rotor.

7. The angular-velocity control device according to claim 6, wherein the magnetic moments of the braking magnets are added together in a non-zero component in said plane perpendicular to the rotation axis of the rotor so that the braking magnets also enable the rotor to be oriented along the terrestrial magnetic field.

8. The angular-velocity control device according to claim 6, wherein the magnetic moments of several of the braking magnets are substantially perpendicular to said plane perpendicular to the rotation axis of the rotor, so that their magnetic field passes through said plane perpendicular to the rotation axis of the rotor to induce eddy currents in at least two zones of the stator body located facing on either side of said plane perpendicular to the rotation axis of the rotor.

9. The angular-velocity control device according to claim 6, wherein the magnetic moments of several of the braking magnets form an oblique angle with respect to said plane perpendicular to the rotation axis of the rotor.

10. A spacecraft comprising at least one angular-velocity control device according to claim 1.

11. The spacecraft according to claim 10, further comprising means for controlling attitude on three axes adapted to stabilize the attitude of the spacecraft in activity, said angular-velocity control device acting simultaneously on the means for controlling the attitude of the spacecraft in activity and exerting a negligible action with respect to these means for controlling the attitude of the spacecraft in activity.

12. The spacecraft according to claim 10, wherein said angular-velocity control device is arranged so that the rotation axis of the rotor forms an angle of less than or equal to 45° with a greatest-inertia axis of the spacecraft, so that the out-of-service spacecraft tends towards a rotation movement about this greatest-inertia axis.
